(19) United States
(12) Patent Application Publication
(10) Pub. No.: US 2011/0063519 A1
(43) Pub. Date: Mar. 17, 2011

(54) CARRIER RECOVERY DEVICE AND METHOD, AND DEMODULATOR

(75) Inventor: Teruaki HASEGAWA, Osaka (JP)

(73) Assignee: PANASONIC CORPORATION, Osaka (JP)

(21) Appl. No.: 12/951,351

(22) Filed: Nov. 22, 2010

Related U.S. Application Data
(63) Continuation of application No. PCT/JP2009/002275, filed on May 22, 2009.

(30) Foreign Application Priority Data
May 22, 2008 (JP) 2008-134760

(51) Int. Cl. H04N 5/455

(52) U.S. Cl. 348/726; 348/E05.113

(57) ABSTRACT

A carrier recovery device includes a first carrier recovery unit configured to multiply a baseband signal by a first carrier to obtain a first demodulated signal, and generate the first carrier based on a first phase error in a pilot signal extracted from the first demodulated signal, a second carrier recovery unit configured to multiply the baseband signal by a second carrier to obtain a second demodulated signal, and generate the second carrier based on a second phase error in a pilot signal extracted from the second demodulated signal, and a selector configured to select one of the first and second demodulated signals which has been obtained by one of the first and second carrier recovery units whose carrier recovery operation has reached a predetermined steady state earlier than that of the other, based on the first phase error and the second phase error, and output the selected demodulated signal.

### CROSS-REFERENCE TO RELATED APPLICATIONS

This is a continuation of PCT International Application PCT/JP2009/002275 filed on May 22, 2009, which claims priority to Japanese Patent Application No. 2008-134760 filed on May 22, 2008. The disclosures of these applications including the specifications, the drawings, and the claims are hereby incorporated by reference in their entirety.

### BACKGROUND

The technology disclosed herein relates to carrier recovery devices used in demodulation of a modulated signal containing a pilot signal.

In recent years, digital video has become widespread, and digital broadcasting services have been commenced in many countries in the fields of satellite broadcasting, CATV, and terrestrial broadcasting. The transmission technique has been selected which is suitable for characteristics of each transmission channel. For example, vestigial-sideband (VSB) modulation is used in digital terrestrial broadcasting in the U.S. Systems for demodulating digital modulated signals which are used in such broadcasting are described in a number of documents (see, for example, Taga, Ishikawa, and Komatsu, “A Study On QPSK Demodulation System,” ITEJ Technical Report, August 1991, Vol. 15, No. 46, CE'91-42 (FIG. 3)).

For example, when carrier recovery is performed from a VSB modulated signal containing a pilot signal, the pilot signal is extracted, and a frequency error and a phase error are obtained from a difference between the pilot signal and a reference signal.

### SUMMARY

In order to reduce the time required for carrier recovery operation of a carrier recovery device to reach a steady state, it is necessary to optimize demodulation parameters relating to carrier recovery, such as the bandwidth of a pilot extraction filter, the gain of a loop filter, and the like. However, it is difficult to obtain the optimum values under various conditions. Moreover, the demodulation parameters need to be changed, depending on phase noise of a pilot signal, in order to maintain the carrier recovery operation. However, the change of the demodulation parameters affects detection of the phase noise, and therefore, it is difficult to continue correct carrier recovery operation.

In some states of the transmission channel, for example, when there is a reflected wave, the pilot signal may be damaged or eliminated. Therefore, it may take a long time for carrier recovery operation to reach a steady state, or demodulation performance may be decreased.

The detailed description describes implementations of a technique of reducing the time required for carrier recovery operation of a carrier recovery device to reach a steady state and a technique of continuing correct carrier recovery operation.

The detailed description also describes implementations of a technique of reducing or preventing a decrease in demodulation performance when pilot signals cannot be properly received while maintaining good response to phase noise when pilot signals can be properly received.

An example carrier recovery device of the present disclosure includes a first carrier recovery unit configured to multiply a baseband signal by a first carrier to obtain a first demodulated signal, extract a pilot signal from the first demodulated signal, and generate the first carrier based on a first phase error in the pilot signal extracted from the first demodulated signal, a second carrier recovery unit configured to multiply the baseband signal by a second carrier to obtain a second demodulated signal, extract a pilot signal from the second demodulated signal, and generate the second carrier based on a second phase error in the pilot signal extracted from the second demodulated signal, and a selector configured to select one of the first and second demodulated signals which has been obtained by one of the first and second carrier recovery units whose carrier recovery operation has reached a predetermined steady state earlier than that of the other, based on the first phase error and the second phase error, and output the selected demodulated signal.

With this carrier recovery device, one of the first and second demodulated signals which has been obtained by the carrier recovery unit whose carrier recovery operation has reached a predetermined steady state earlier is selected, whereby the time required for carrier recovery operation of the carrier recovery device to reach a steady state can be reduced.

Another example carrier recovery device of the present disclosure includes a multiplier configured to multiply a baseband signal by a carrier, and output the result as a demodulated signal, a pilot signal extractor configured to extract a pilot signal from the demodulated signal, an error detector configured to detect a phase error in the pilot signal extracted from the demodulated signal, a limiter configured to cause the phase error to decrease or remain the same based on the pilot signal extracted from the demodulated signal, and output the resultant phase error, a loop filter configured to smooth the output of the limiter, and output the smoothed output, and a variable frequency oscillator configured to generate a signal corresponding to the output of the loop filter, and output the signal as the carrier.

An example demodulator of the present disclosure includes a first carrier recovery unit configured to multiply a baseband signal by a first carrier to obtain a first demodulated signal, extract a pilot signal from the first demodulated signal, and generate the first carrier based on a first phase error in the pilot signal extracted from the first demodulated signal, a second carrier recovery unit configured to multiply the baseband signal by a second carrier to obtain a second demodulated signal, extract a pilot signal from the second demodulated signal, and generate the second carrier based on a second phase error in the pilot signal extracted from the second demodulated signal, a selector configured to select one of the first and second demodulated signals which has been obtained by one of the first and second carrier recovery units whose carrier recovery operation has reached a predetermined steady state earlier than that of the other, based on the first phase error and the second phase error, and output the selected demodulated signal, and an equalizer configured to equalize the demodulated signal selected by the selector.

Another example demodulator of the present disclosure includes a multiplier configured to multiply a baseband signal by a carrier, and output the result as a demodulated signal, a pilot signal extractor configured to extract a pilot signal from the demodulated signal, an error detector configured to detect a phase error in the pilot signal extracted from the demodulated signal, a limiter configured to cause the phase error to decrease or remain the same based on the pilot signal extracted from the demodulated signal, and output the resultant phase error, a loop filter configured to smooth the output of the limiter, and output the smoothed output, a variable frequency oscillator configured to generate a signal corresponding to the output of the loop filter, and output the signal as the carrier, and an equalizer configured to equalize the demodulated signal.

An example carrier recovery method of the present disclosure includes a first carrier recovery step of multiplying a baseband signal by a first carrier to obtain a first demodulated signal, extracting a pilot signal from the first demodulated signal, and generating the first carrier based on a first phase error in the pilot signal extracted from the first demodulated signal, a second carrier recovery step of multiplying the baseband signal by a second carrier to obtain a second demodulated signal, extracting a pilot signal from the second demodulated signal, and generating the second carrier based on a second phase error in the pilot signal extracted from the second demodulated signal, and a selection step of selecting one of the first and second demodulated signals which has been obtained by one of the first and second carrier recovery steps whose carrier recovery operation has reached a predetermined steady state earlier than that of the other, based on the first phase error and the second phase error.

Another example carrier recovery method of the present disclosure includes a multiplication step of multiplying a baseband signal by a carrier, and outputting the result as a demodulated signal, a pilot signal extraction step of extracting a pilot signal from the demodulated signal, an error detection step of detecting a phase error in the pilot signal extracted from the demodulated signal, a limitation step of causing the phase error to decrease or remain the same based on the pilot signal extracted from the demodulated signal, and outputting the resultant phase error, a loop filter step of smoothing the phase error after processing by the limitation step, and a variable frequency oscillation step of generating as the carrier a signal corresponding to the phase error smoothed by the loop filter step.

According to the examples of the present disclosure, a plurality of carrier recovery units are provided, whereby the time required for carrier recovery operation of a carrier recovery device to reach a steady state can be reduced, and the carrier recovery operation can be accurately continued. Moreover, when a pilot signal cannot be properly received, a phase error in the pilot signal is utilized with suitable modification, whereby the reduction in demodulation performance can be reduced or prevented.

### BRIEF DESCRIPTION OF THE DRAWINGS

FIG. 1 is a block diagram showing a configuration of a demodulator including a carrier recovery device according to a first embodiment of the present disclosure.

FIG. 2 is a block diagram showing an example configuration of a loop filter of FIG. 1.

FIG. 3 is a graph showing an example pilot signal amplitude PIA input to a limiter of FIG. 1, and an example input phase error EN and an example output phase error EL when the pilot signal amplitude PIA is input.

FIG. 4 is a block diagram showing an example configuration of a selector of FIG. 1.

FIG. 5 is a block diagram showing a variation of the carrier recovery device of FIG. 1.

FIG. 6 is a block diagram showing a configuration of a demodulator including a carrier recovery device according to a second embodiment of the present disclosure.

FIG. 7 is a block diagram showing a configuration of a demodulator including a carrier recovery device according to a third embodiment of the present disclosure.

### DETAILED DESCRIPTION

Embodiments of the present disclosure will be described hereinafter with reference to the accompanying drawings. Components indicated by reference characters whose last two digits are the same correspond to each other, i.e., are the same or similar components.

Functional blocks described herein may each be typically implemented by hardware. For example, each functional block is formed as a part of an integrated circuit (IC) on a semiconductor substrate. As used herein, ICs include large-scale integrated circuits (LSIs), application-specific integrated circuits (ASICs), gate arrays, field programmable gate arrays (FPGAs), and the like. Alternatively, a portion of or all functional blocks may be implemented by software. For example, such functional blocks may each be implemented by a program executable by a processor. In other words, each functional block described herein may be implemented by hardware or software or in any combination thereof.

### First Embodiment

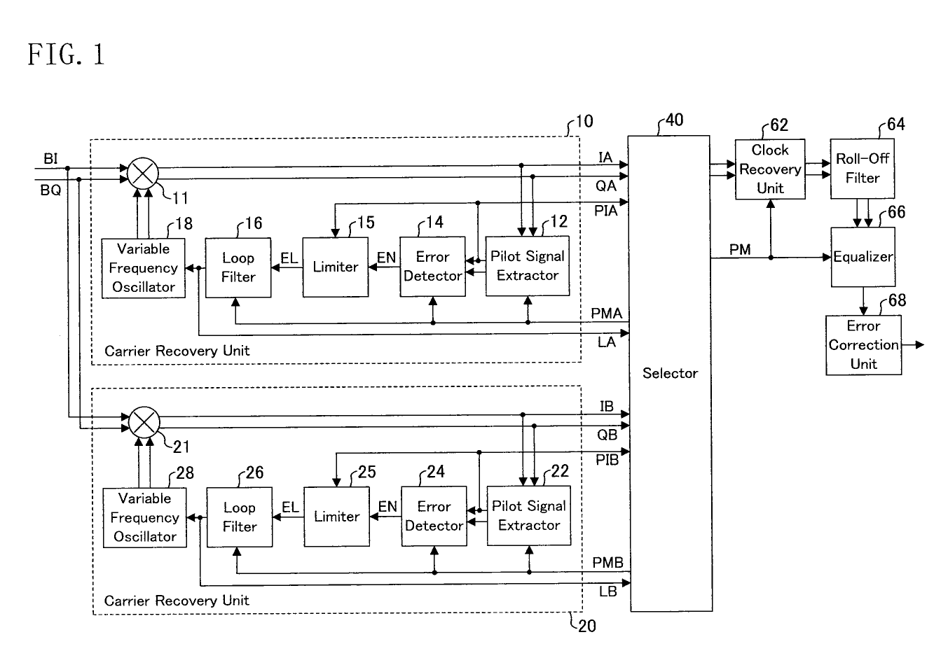

FIG. 1 is a block diagram showing a configuration of a demodulator including a carrier recovery device according to a first embodiment of the present disclosure. The demodulator of FIG. 1 includes carrier recovery units 10 and 20, a selector 40, a clock recovery unit 62, a roll-off filter 64, an equalizer 66, and an error correction unit 68. The carrier recovery units 10 and 20 and the selector 40 are included in the carrier recovery device.

The carrier recovery unit 10 includes a multiplier 11, a pilot signal extractor 12, an error detector 14, a limiter 15, a loop filter 16, and a variable frequency oscillator 18. The carrier recovery unit 20 includes a multiplier 21, a pilot signal extractor 22, an error detector 24, a limiter 25, a loop filter 26, and a variable frequency oscillator 28.

It is assumed that a signal compliant with the advanced television systems committee (ATSC) standards is received and subjected to quadrature detection to obtain a baseband signal BI/BQ, and the baseband signal BI/BQ is input to the carrier recovery units 10 and 20 of FIG. 1. The received signal, which has been modulated by VSB modulation, contains a pilot signal. The baseband signal BI/BQ, which is a complex signal, contains an inphase signal BI and a quadrature signal BQ.

The carrier recovery unit 10 will be described. When quadrature detection is performed upstream from the carrier recovery unit 10, a carrier used for the quadrature detection does not necessarily always have a correct frequency and a correct phase. Therefore, there remain frequency and phase offsets in the inphase signal BI and the quadrature signal BQ.

The baseband signal BI/BQ input to the carrier recovery units 10 and 20 of FIG. 1 is represented by:

(Si+jSq)×exp(j(ΔWt+Δθ)) (1)

ΔW: frequency offset

Δθ: phase offset

where Si is the inphase signal (I-signal) and Sq is the quadrature signal (Q-signal).

The variable frequency oscillator 18 outputs, as a recovered carrier, a signal which is the conjugate of the carrier component exp(j(ΔWt+Δθ)) of the signal represented by expression (1). The conjugate signal is represented by:

exp(−j(ΔWt+Δθ)) (2)

The multiplier 11 performs complex multiplication with respect to the output of the variable frequency oscillator 18 and the input baseband signal BI/BQ as represented by:

(Si+jSq)×exp(j(ΔWt+Δθ))×exp(−j(ΔWt+Δθ))=(Si+jSq) (3)

Thus, the multiplier 11 removes the frequency and phase offsets of the input baseband signal BI/BQ and outputs a demodulated signal IA/QA represented by expression (3).

The pilot signal extractor 12 extracts a pilot signal from the demodulated signal IA/QA, and outputs the pilot signal to the error detector 14. The error detector 14 detects and outputs a difference between the phase of the extracted pilot signal and a reference phase as a phase error EN of the pilot signal. When the variable frequency oscillator 18 is outputting the signal of expression (2), the error detector 14 detects zero as the phase error EN. When the variable frequency oscillator 18 is outputting a signal which has a phase error with respect to the signal of expression (2), the error detector 14 detects the phase error.

The limiter 15 modifies the phase error EN to have a value which corresponds to the phase error EN and is less than or equal to the phase error EN, based on the pilot signal extracted by the pilot signal extractor 12, and outputs the modified phase error EL. The loop filter 16 smoothes the phase error EL output from the limiter 15, i.e., removes high-frequency components from the phase error EL, and outputs the resultant phase error EL as an output signal LA to the variable frequency oscillator 18 and the selector 40. The variable frequency oscillator 18 generates an oscillating signal having a frequency corresponding to the output signal LA of the loop filter 16, and outputs the oscillating signal as a recovered carrier to the multiplier 11.

A characteristic of each of the pilot signal extractor 12, the error detector 14, and the loop filter 16 is set based on a demodulation parameter PMA which is output from the selector 40.

The phase control loop thus configured is a negative feedback loop. Therefore, by the negative feedback loop, a carrier whose phase is synchronous with that of the received digital modulated signal is recovered by the variable frequency oscillator 18. The recovered carrier is the conjugate of the carrier component of the baseband signal input to the multiplier 11, and therefore, there is substantially no frequency and phase errors therebetween, whereby a correct demodulated signal can be obtained.

The carrier recovery unit 20 has the same configuration as that of the carrier recovery unit 10, except that a characteristic of each of the pilot signal extractor 22, the error detector 24, and the loop filter 26 is set based on a demodulation parameter PMB which is output from the selector 40. The carrier recovery units 10 and 20 are assumed to have different characteristics.

The selector 40 selects one of the demodulated signal IA/QA output from the carrier recovery unit 10 and a demodulated signal IB/QB output from the carrier recovery unit 20, and outputs the selected demodulated signal to the clock recovery unit 62. Here, the selector 40 selects the demodulated signal which is obtained by one of the carrier recovery units 10 and 20 whose carrier recovery operation has reached a predetermined steady state earlier than that of the other. The selector 40 also generates the demodulation parameters PMA and PMB and another demodulation parameter PM based on phase noise of the loop filter output of the carrier recovery unit 10 or 20.

The selected demodulated signal is subjected to timing synchronization by the clock recovery unit 62, waveform shaping by the roll-off filter 64, waveform equalization by the equalizer 66, and demapping and error correction by the error correction unit 68 successively in this stated order. The error correction unit 68 outputs error-corrected data. The equalizer 66 includes, for example, a finite impulse response (FIR) filter and an infinite impulse response (IIR) filter. A loop filter gain of the clock recovery unit 62 and a filter coefficient updating step size of the equalizer 66 are controlled based on the demodulation parameter PM output from the selector 40. The processes of the clock recovery unit 62, the roll-off filter 64, and the equalizer 66 may be performed in an order other than that described above.

The demodulator of FIG. 1 further includes a field synchronizer (not shown). The field synchronizer detects field synchronization from the demodulated signal selected by the selector 40, and outputs the result of the detection to the selector 40.

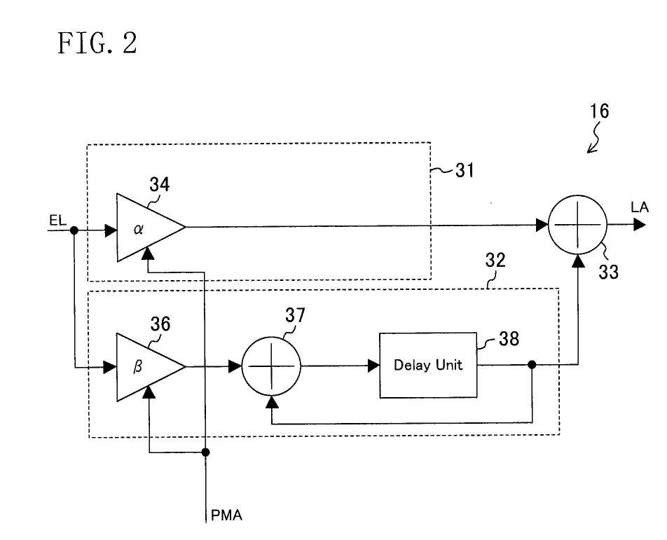

FIG. 2 is a block diagram showing an example configuration of the loop filter 16 of FIG. 1. The loop filter 16 includes a direct circuit 31, an integration circuit 32, and an adder 33. The direct circuit 31 includes an amplifier 34. The integration circuit 32 includes an amplifier 36, an adder 37, and a delay unit 38. The adder 33 adds the output of the direct circuit 31 and the output of the integration circuit 32, and outputs the result of the addition as a control signal LA.

The amplifier 34 of the direct circuit 31 amplifies the phase error EL output from the limiter 15 by a gain α. The variable frequency oscillator 18 advances (or delays) the phase of its output signal in proportion to the input control signal LA. Therefore, the direct circuit 31 advances (or delays) the phase of the output signal of the variable frequency oscillator 18 linearly with respect to the phase error EL. In other words, the direct circuit 31 corrects a phase error in the carrier recovery process.

On the other hand, in the integration circuit 32, the amplifier 36 amplifies the input phase error EL by a gain β. The adder 37 adds the output of the amplifier 36 and the output of the delay unit 38, and outputs the result of the addition. The delay unit 38 delays the output of the adder 37, and outputs the delayed output to the adders 33 and 37. A loop which is formed by the adder 37 and the delay unit 38 has an integration function. Therefore, the integration circuit 32 controls a frequency of the output signal of the variable frequency oscillator 18 based on the phase error signal. In other words, the integration circuit 32 corrects a frequency error in the carrier recovery process.

The gain α of the amplifier 34 and the gain β of the amplifier 36 are set based on the demodulation parameter PMA. The loop filter 26 has the same configuration as that of the loop filter 16, except that the amplifier gains α and β are set based on the demodulation parameter PMB. Note that only the gain α or β may be set based on the demodulation parameter PMA or PMB.

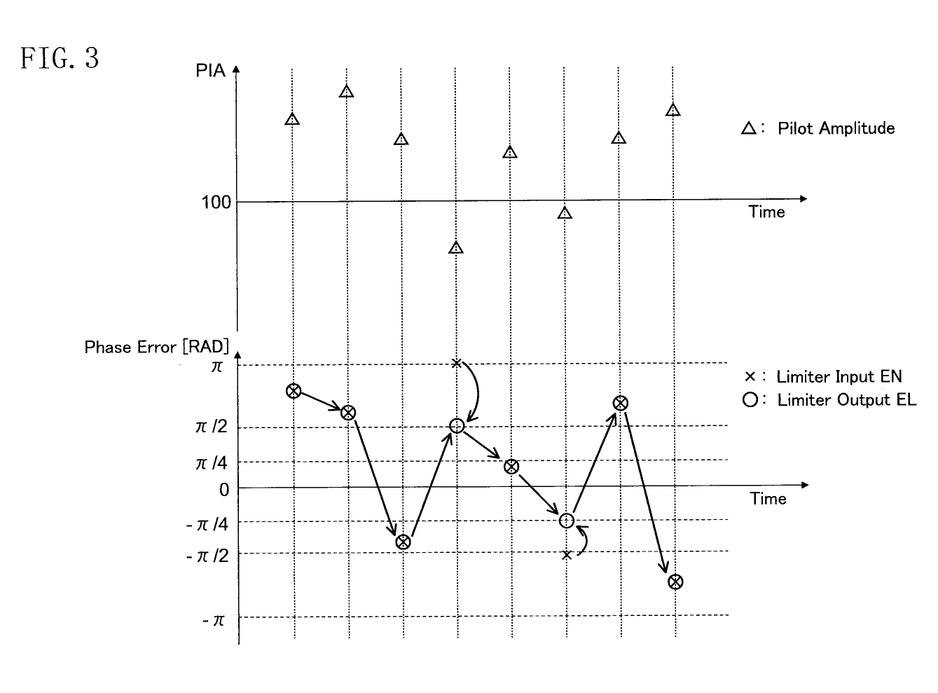

FIG. 3 is a graph showing an example pilot signal amplitude PIA input to the limiter 15 of FIG. 1, and an example input phase error EN and an example output phase error EL when the pilot signal amplitude PIA is input.

The limiter 15 compares the pilot signal amplitude PIA (a component (I-axis signal) having the same phase as the reference phase, of the pilot signal extracted by the pilot signal extractor 12) with a set threshold (here, the threshold is assumed to be 100). When the pilot signal amplitude PIA is less than the threshold, the limiter 15 determines that the reliability of the phase error EN output from the error detector 14 is low, modifies and reduces the value of the phase error EN by a half, and outputs the modified phase error EN as the phase error EL. When the pilot signal amplitude PIA is greater than or equal to the threshold, the limiter 15 determines that the reliability of the phase error EN output from the error detector 14 is high, and outputs the phase error EN directly as the phase error EL.

Thus, when the pilot signal amplitude PIA is less than the threshold, the limiter 15 reduces the value of the phase error EN to a value corresponding to that value. Therefore, even when the pilot signal is damaged or eliminated and therefore cannot be properly received, it is possible to reduce or prevent the reduction in demodulation performance which is caused by a residual phase error remaining in the negative feedback loop of the carrier recovery unit. Moreover, it is possible to prevent reduced response to phase noise when the pilot signal can be properly received.

The limiter 15 may compare the pilot signal amplitude PIA with a plurality of thresholds. For example, the limiter 15 may modify and reduce the value of the phase error EN by a half when the pilot signal amplitude PIA is less than a threshold TAA, and may modify and reduce the value of the phase error EN by a factor of four when the pilot signal amplitude PIA is less than a threshold TAB (TAB<TAA).

The threshold may have a value other than that described above. When the pilot signal amplitude PIA is less than the threshold, the limiter 15 may modify the value of the phase error EN to have a value other than ½ of that value. Specifically, when the pilot signal amplitude PIA is less than the threshold, the limiter 15 may modify the value of the phase error EN to have a reduced absolute value.

The limiter 15 can be easily constructed by combining an amplifier and a selector, and therefore, the specific configuration of the limiter 15 will not be described. Note that the limiters 15 and 25 of FIG. 1 may be removed.

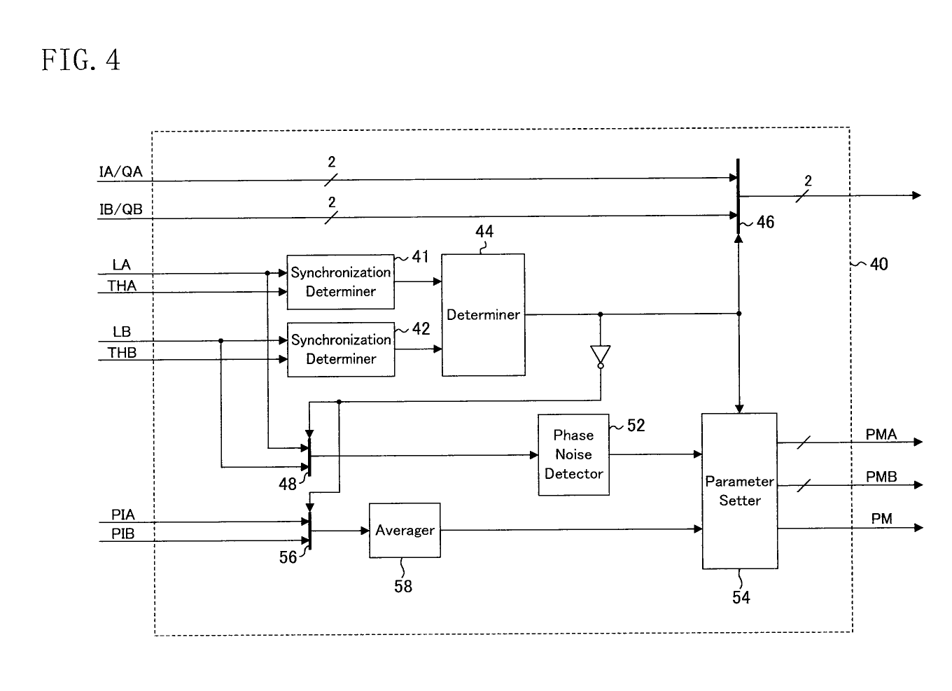

FIG. 4 is a block diagram showing an example configuration of the selector 40 of FIG. 1. The selector 40 includes synchronization determiners 41 and 42, a determiner 44, selectors 46, 48, and 56, a phase noise detector 52, a parameter setter 54, and an averager 58.

The synchronization determiner 41, when the range of fluctuation of the control signal LA output from the carrier recovery unit 10 is less than or equal to a set threshold THA, determines that the operation of the carrier recovery unit 10 has reached the steady state, and outputs the result of the determination. The synchronization determiner 42, when the range of fluctuation of the control signal LB output from the carrier recovery unit 20 is less than or equal to a set threshold THB, determines that the operation of the carrier recovery unit 20 has reached the steady state, and outputs the result of the determination.

In its initial state, the determiner 44 outputs the determination result so that the selector 46 selects the output signal of the carrier recovery unit 10, for example. The determiner 44 determines in which of the carrier recovery units 10 and 20 the carrier recovery operation has reached the steady state earlier than that of the other, based on the determination results of the synchronization determiners 41 and 42, and outputs the result of the determination. Based on the determination result of the determiner 44, the selector 46 selects the output signal (the demodulated signal IA/QA or IB/QB) of one of the carrier recovery units 10 and 20 whose carrier recovery operation has reached the steady state earlier than that of the other, and outputs the selected output signal to the clock recovery unit 62. After field synchronization is detected by the field synchronizer, the determiner 44 fixes its output.

Note that the determiner 44 selects the carrier recovery unit 10, which has been selected since the initial state, with higher priority. Specifically, when the carrier recovery operation has reached the steady state at the same time in the carrier recovery unit 10 and 20, the determiner 44 outputs the result of the determination so that the selector 46 selects the demodulated signal IA/QA of the carrier recovery unit 10. Alternatively, even when it is determined that the operation of the carrier recovery unit 20 has reached the steady state earlier, the determiner 44 may output the result of the determination so that the selector 46 selects the demodulated signal IA/QA of the carrier recovery unit 10 until a predetermined time has passed.

As described above, the carrier recovery device of FIG. 1 includes the carrier recovery units 10 and 20 which have different characteristics, and selects a demodulated signal output from one of them whose carrier recovery operation has reached the steady state earlier, whereby the time required for carrier recovery operation of the carrier recovery device to reach the steady state can be reduced, and the use of a stable demodulated signal can be more quickly started. Although the case where the carrier recovery device includes two carrier recovery units has been described, three or more carrier recovery units may be provided, and a demodulated signal of one of the carrier recovery units whose carrier recovery operation has reached the steady state earliest may be selected.

The selector 48 selects the loop filter output LA of the carrier recovery unit 10 or the loop filter output LB of the carrier recovery unit 20 based on the output of the determiner 44, and outputs the selected loop filter output LA or LB to the phase noise detector 52. Here, the selector 48 selects the loop filter output LA or LB of the carrier recovery unit 10 or 20 which has not been selected by the selector 46. For example, when the selector 46 has selected the output of the carrier recovery unit 10, the selector 48 selects the loop filter output LB of the carrier recovery unit 20.

The phase noise detector 52 calculates the amount of phase noise from the loop filter output selected by the selector 48, and outputs the phase noise amount to the parameter setter 54. In its initial state, the parameter setter 54 outputs predetermined parameters as the demodulation parameters PMA, PMB, and PM. After field synchronization is detected, the parameter setter 54 obtains and outputs the demodulation parameters PMA, PMB, and PM based on the phase noise amount calculated by the phase noise detector 52.

The demodulation parameter PMA is used to set the bandwidth of the pilot extraction filter of the pilot signal extractor 12 and the gains α and β of the loop filter 16 in the carrier recovery unit 10. The demodulation parameter PMB is used to set the bandwidth of the pilot extraction filter of the pilot signal extractor 22 and the gains of the loop filter 26 in the carrier recovery unit 20.

The parameter setter 54 generates the demodulation parameter PMA or PMB so that the bandwidth of the pilot extraction filter of the pilot signal extractor 12 or 22 increases, or the gains of the loop filter 16 or 26 increase, with an increase in phase noise. The parameter setter 54 also generates the demodulation parameter PM so that the loop filter gain of the clock recovery unit 62 increases, and the filter coefficient updating step size of the equalizer 66 increases, with an increase in phase noise.

As a result, the response of the carrier recovery device to phase noise when phase noise is large can be improved. When phase noise is small, the bandwidth of the pilot extraction filter of the pilot signal extractor 12 or 22 is narrow, the loop filter gain of the clock recovery unit 62 and the gains of the loop filter 16 or 26 are small, and the filter coefficient updating step size of the equalizer 66 is small. Therefore, it is possible to reduce or prevent the reduction in demodulation performance which is caused by a residual phase error remaining in the negative feedback loop of the carrier recovery device. Note that the characteristic of only one of the clock recovery unit 62 and the equalizer 66 may be controlled based on the demodulation parameter PM.

The demodulation parameters PMA and PMB are input to the carrier recovery units 10 and 20, respectively. The parameter setter 54 continues to update, based on the determination result of the determiner 44, (i) one of the demodulation parameter PMA or PMB corresponding to the carrier recovery unit 10 or 20, which has been selected by the selector 46, and (ii) the demodulation parameter PM.

Thus, the carrier recovery device of FIG. 1 uses the output of the carrier recovery unit selected by the selector 46 as a demodulation output to the clock recovery unit 62, and also uses the loop filter output of the carrier recovery unit not selected by the selector 46 for detection of phase noise. In other words, the demodulation parameter of the selected carrier recovery unit which generates the demodulation output is changed based on the detected phase noise, but the change does not affect the result of detection of phase noise by the other carrier recovery unit. Therefore, the demodulation parameter can be maintained at an appropriate value corresponding to the state of the transmission channel while phase noise detection is correctly performed, whereby carrier recovery operation can be correctly continued.

Note that instead of changing the gains of the loop filters of the carrier recovery units 10 and 20, the same effect may be achieved in another manner. For example, the amplitude of the baseband signal BI/BQ may be changed based on the demodulation parameter PMA (or PMB) before the baseband signal BI/BQ is input to the carrier recovery unit 10 (or 20).

The parameter setter 54 may update the demodulation parameter PMA or PMB which will be input to one of the carrier recovery unit 10 and 20 which has not been selected by the selector 46 so that phase noise can be more easily detected.

The selector 56 selects the pilot signal amplitude (I-axis signal) PIA or PIB of one of the carrier recovery units 10 and 20 which has not been selected by the selector 46. For example, when the selector 46 selects the output of the carrier recovery unit 10, the selector 56 selects the pilot signal amplitude PIB of the carrier recovery unit 20. The averager 58 performs an averaging process with respect to the pilot signal amplitude selected by the selector 56, and outputs the resultant average value to the parameter setter 54.

The parameter setter 54 may obtain the demodulation parameters PMA, PMB, and PM based on the average value obtained by the averager 58 instead of the phase noise amount obtained by the phase noise detector 52. In this case, the parameter setter 54 generates the demodulation parameter PMA or PMB so that the bandwidth of the pilot extraction filter of the pilot signal extractor 12 or 22 increases, and the gains of the loop filter 16 or 26 increase, with an increase in the obtained average value. The parameter setter 54 also generates the demodulation parameter PM so that the loop filter gain of the clock recovery unit 62 increases, and the filter coefficient updating step size of the equalizer 66 decreases, with an increase in the calculated average value.

As a result, the response of the carrier recovery device to phase noise when the pilot signal amplitude is large can be improved. When the pilot signal amplitude is small (i.e., the pilot signal is damaged or eliminated, and therefore, the pilot signal cannot be properly received), the bandwidth of the pilot extraction filter of the pilot signal extractor 12 or 22 is narrow, the loop filter gain of the clock recovery unit 62 and the gains of the loop filter 16 or 26 are small, and the filter coefficient updating step size of the equalizer 66 is large. Therefore, it is possible to reduce or prevent the reduction in demodulation performance which is caused by a residual phase error remaining in the negative feedback loop of the carrier recovery unit.

Note that the parameter setter 54 may obtain the demodulation parameter PMA, PMB and PM based on both the phase noise amount obtained by the phase noise detector 52 and the average value obtained by the averager 58.

Alternatively, the parameter setter 54 may generate the demodulation parameter PMA, PMB, or PM so that at least one (but not all) of the bandwidths of the pilot extraction filters of the pilot signal extractors 12 and 22, the gains of the loop filters 16 and 26, the loop filter gain of the clock recovery unit 62, and the filter coefficient updating step size of the equalizer 66 has a value corresponding to the phase noise amount obtained by the phase noise detector 52 or the average value obtained by the averager 58.

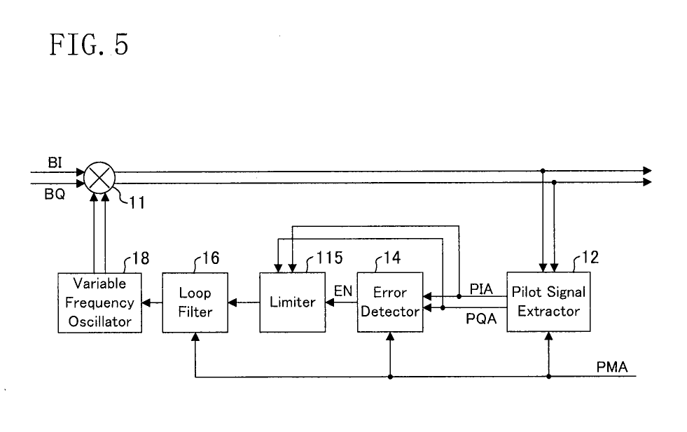

FIG. 5 is a block diagram showing a variation of the carrier recovery unit 10 of FIG. 1. The carrier recovery unit of FIG. 5 is different from that of FIG. 1 in that a limiter 115 is provided instead of the limiter 15.

The limiter 115 is different from the limiter 15 in that the limiter 115 compares, with a set threshold, the power of the pilot signal instead of the pilot signal amplitude PIA. The limiter 115 obtains, as the pilot signal power, the sum of the square of the pilot signal amplitude PIA and the square of a pilot signal amplitude PQA (a component (Q-axis signal) in quadrature with the reference phase, of the pilot signal extracted by the pilot signal extractor 12). The limiter 115 also sets the threshold, and a factor by which the phase error EN is modified, to appropriate values. The limiter 115 has the same configuration as that of the limiter 15, except for the foregoing. Also in the carrier recovery unit 20 of FIG. 1, a limiter similar to the limiter 115 is used instead of the limiter 25.

When the limiter 115 is used, then if the pilot signal is unstable, the phase error can be detected with higher accuracy than when the pilot signal amplitude (I-axis signal) is used. Therefore, when the response of the carrier recovery device to phase noise when the phase noise is large can be improved. Moreover, even when the pilot signal is damaged or eliminated and therefore cannot be properly received, it is possible to reduce or prevent the reduction in demodulation performance which is caused by a residual phase error remaining in the negative feedback loop of the carrier recovery device.

### Second Embodiment

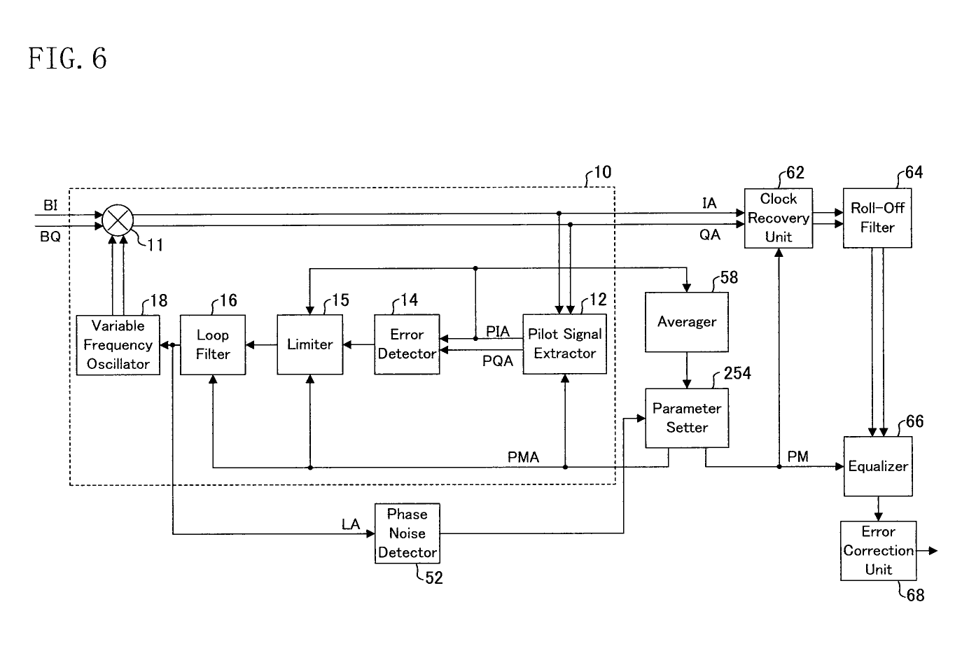

FIG. 6 is a block diagram showing a configuration of a demodulator including a carrier recovery device according to a second embodiment of the present disclosure. The demodulator of FIG. 6 includes a carrier recovery unit 10, a phase noise detector 52, a parameter setter 254, an averager 58, a clock recovery unit 62, a roll-off filter 64, an equalizer 66, and an error correction unit 68. The carrier recovery unit 10, the phase noise detector 52, the parameter setter 254, and the averager 58 are included in the carrier recovery device. The same components as those described in the first embodiment are indicated by the same reference characters.

The phase noise detector 52 calculates the amount of phase noise from the loop filter output LA, and outputs the phase noise amount to the parameter setter 254. The averager 58 performs an averaging process with respect to the pilot signal amplitude PIA, and outputs the resultant average value to the parameter setter 254. The parameter setter 254 obtains the demodulation parameters PMA and PM based on at least one of the phase noise amount obtained by the phase noise detector 52 or the average value obtained by the averager 58, as does the parameter setter 54 of FIG. 4.

Although the demodulator of FIG. 6 includes a single carrier recovery unit, the carrier recovery unit includes the limiter 15. Therefore, even when the pilot signal is damaged or eliminated, it is possible to reduce or prevent the reduction in demodulation performance which is caused by a residual phase error remaining in the negative feedback loop of the carrier recovery unit. Moreover, it is possible to prevent reduced response to phase noise when the pilot signal can be properly received.

### Third Embodiment

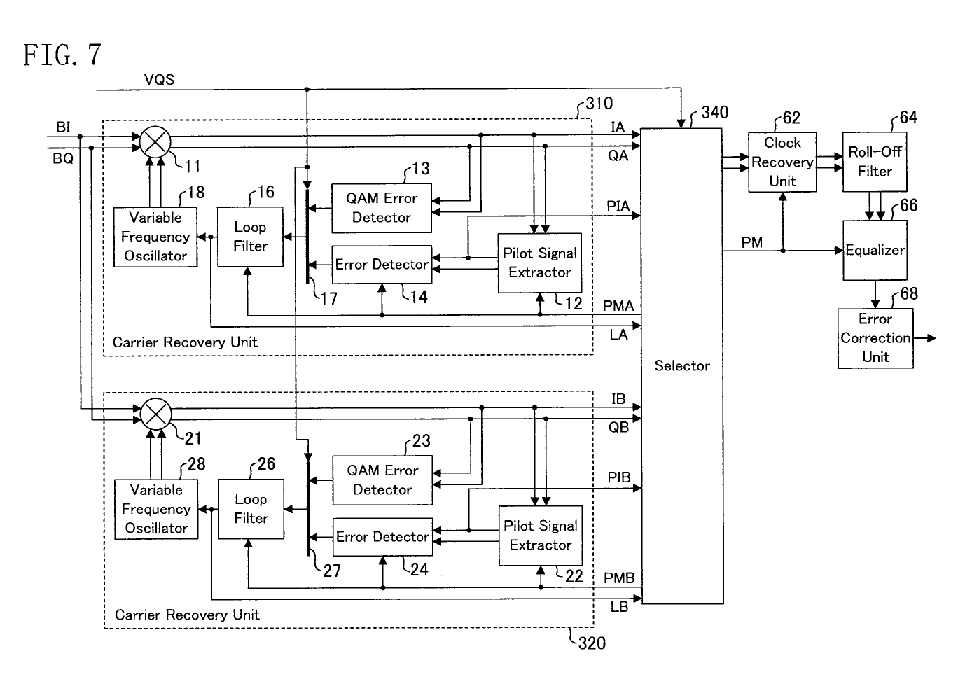

FIG. 7 is a block diagram showing a configuration of a demodulator including a carrier recovery device according to a third embodiment of the present disclosure. The demodulator of FIG. 7 is configured to be able to receive not only VSB modulated signals, but also quadrature amplitude modulation (QAM) modulated signals.

The demodulator of FIG. 7 includes carrier recovery units 310 and 320, a selector 340, a clock recovery unit 362, a roll-off filter 364, an equalizer 366, and an error correction unit 368. The carrier recovery units 310 and 320 and the selector 340 are included in the carrier recovery device. The same components as those described in the first embodiment are indicated by the same reference characters.

The carrier recovery unit 310 of FIG. 7 is different from the carrier recovery unit 10 of FIG. 1 in that a QAM error detector 13 and a selector 17 are provided instead of the limiter 15. The carrier recovery unit 320 is different from the carrier recovery unit 20 of FIG. 1 in that a QAM error detector 23 and a selector 27 are provided instead of the limiter 25.

The QAM error detector 13 detects a phase error in a received QAM modulated signal using the demodulated signal IA/QA output from the multiplier 11, and outputs the detected phase error. The selector 17 selects the phase error obtained by the QAM error detector 13 or the phase error obtained by the error detector 14 based on a VSB/QAM switch signal VQS, and outputs the selected phase error to the loop filter 16.

The QAM error detector 23 detects a phase error in a received QAM modulated signal using the demodulated signal IB/QB output from the multiplier 21, and outputs the detected phase error. The selector 27 selects the phase error obtained by the QAM error detector 23 or the phase error obtained by the error detector 24 based on the VSB/QAM switch signal VQS, and outputs the selected phase error to the loop filter 26.

The clock recovery unit 362, the roll-off filter 364, the equalizer 366, and the error correction unit 368 are the same as the clock recovery unit 62, the roll-off filter 64, the equalizer 66, and the error correction unit 68 of FIG. 1, except that the demodulated signal obtained from the QAM modulated signal can also be processed.

In the carrier recovery device of FIG. 7, most of the components which are used when the VSB modulated signal is received can also be used when the QAM modulated signal is received. Therefore, the scale of the device which is capable of receiving both the VSB modulated signal and the QAM modulated signal can be reduced.

Note that the QAM error detectors 13 and 23 may detect a phase error using the output of the equalizer 366 instead of the demodulated signals IA/QA and IB/QB.

Moreover, characteristics of the loop filters 16 and 26 may be switched based on the VSB/QAM switch signal VQS.

Moreover, each of the QAM error detectors 13 and 23 of the carrier recovery unit 310 and 320 of FIG. 7 may be replaced with a national television system committee (NTSC) error detector which detects an error in an NTSC signal.

Thus, the carrier recovery device of FIG. 7 includes two carrier recovery units in order to improve reception performance. This configuration is preferable when VSB modulated signals used in terrestrial broadcasting are received. However, when QAM modulated signals used in cable broadcasting are received, the transmission channel is in good conditions, and therefore, only a single carrier recovery unit may be used. Therefore, when QAM modulated signals are received, the carrier recovery units may receive signals having different frequencies.

In this case, the delay time of delayed waves is not as long as that in terrestrial broadcasting, and the number of taps in the filter included in the equalizer may be less than when VSB modulated signals are received. Therefore, each filter included in the equalizer is divided into two parts, which are in turn used by the two respective carrier recovery units. As a result, a circuit having substantially the same scale as that of the demodulator of FIG. 7 can receive signals on a single channel using two carrier recovery units when receiving VSB modulated signals, and can simultaneously receive signals on two channels when receiving QAM modulated signals.

The many features and advantages of the present disclosure are apparent from the written description, and thus, it is intended by the appended claims to cover all such features and advantages of the present disclosure. Further, since numerous modifications and changes will readily occur to those skilled in the art, it is not desired to limit the present disclosure to the exact construction and operation as illustrated and described. Hence, all suitable modifications and equivalents may be resorted to as falling within the scope of the present disclosure.

As described above, according to the embodiments of the present disclosure, the time required for carrier recovery operation of a carrier recovery device to reach a steady state can be reduced. Therefore, the present disclosure is useful for carrier recovery devices, demodulators, and the like.

What is claimed is:

1. A carrier recovery device comprising:
a first carrier recovery unit configured to
multiply a baseband signal by a first carrier to obtain a first demodulated signal,
extract a pilot signal from the first demodulated signal, and
generate the first carrier based on a first phase error in the pilot signal extracted from the first demodulated signal;
a second carrier recovery unit configured to
multiply the baseband signal by a second carrier to obtain a second demodulated signal,
extract a pilot signal from the second demodulated signal, and
generate the second carrier based on a second phase error in the pilot signal extracted from the second demodulated signal; and
a selector configured to select one of the first and second demodulated signals which has been obtained by one of the first and second carrier recovery units whose carrier recovery operation has reached a predetermined steady state earlier than that of the other, based on the first phase error and the second phase error, and output the selected demodulated signal.

2. The carrier recovery device of claim 1, wherein
the first carrier recovery unit includes
a first multiplier configured to multiply the baseband signal by the first carrier, and output the result as the first demodulated signal,
a first pilot signal extractor configured to extract the pilot signal from the first demodulated signal,
a first error detector configured to detect the first phase error in the pilot signal extracted from the first demodulated signal,
a first loop filter configured to receive and smooth the first phase error, and output the smoothed first phase error, and
a first variable frequency oscillator configured to generate a signal corresponding to the output of the first loop filter, and output the signal as the first carrier, and
the second carrier recovery unit includes
a second multiplier configured to multiply the baseband signal by the second carrier, and output the result as the second demodulated signal,
a second pilot signal extractor configured to extract the pilot signal from the second demodulated signal,
a second error detector configured to detect the second phase error in the pilot signal extracted from the second demodulated signal,
a second loop filter configured to receive and smooth the second phase error, and output the smoothed second phase error, and
a second variable frequency oscillator configured to generate a signal corresponding to the output of the second loop filter, and output the signal as the second carrier.

3. The carrier recovery device of claim 2, wherein
the selector, when a range of fluctuation of the output of the first loop filter becomes less than a threshold earlier than a range of fluctuation of the output of the second loop filter becomes less than another threshold, selects the first demodulated signal, and otherwise selects the second demodulated signal.

4. The carrier recovery device of claim 2, wherein
the selector includes
a phase noise detector configured to obtain a phase noise amount of one of the first and second demodulated signal which has not been selected, and
a parameter setter configured to set a parameter for generating the first carrier into the first carrier recovery unit when the first demodulated signal has been selected, and a parameter for generating the second carrier into the second carrier recovery unit when the second demodulated signal has been selected, based on the phase noise amount obtained by the phase noise detector.

5. The carrier recovery device of claim 2, wherein
the first carrier recovery unit further includes
a first limiter configured to cause the first phase error to decrease or remain the same based on the pilot signal extracted from the first demodulated signal, and output the resultant first phase error to the first loop filter, and
the second carrier recovery unit further includes
a second limiter configured to cause the second phase error to decrease or remain the same based on the pilot signal extracted from the second demodulated signal, and output the resultant second phase error to the second loop filter.

6. The carrier recovery device of claim 5, wherein
the first limiter, when the pilot signal extracted from the first demodulated signal has an amplitude less than a first predetermined value, outputs to the first loop filter a result of multiplying the first phase error by a first predetermined coefficient which is less than one, and otherwise outputs the first phase error to the first loop filter,
the second limiter, when the pilot signal extracted from the second demodulated signal has an amplitude less than the first predetermined value, outputs to the second loop filter a result of multiplying the second phase error by the first predetermined coefficient which is less than one, and otherwise outputs the second phase error to the second loop filter.

7. The carrier recovery device of claim 6, wherein
the first limiter, when the amplitude of the pilot signal extracted from the first demodulated signal is less than a second predetermined value which is less than the first predetermined value, outputs to the first loop filter a result of multiplying the first phase error by a second predetermined coefficient which is less than the first predetermined coefficient, and
the second limiter, when the amplitude of the pilot signal extracted from the second demodulated signal is less than the second predetermined value, outputs to the second loop filter a result of multiplying the second phase error by the second predetermined coefficient.

8. The carrier recovery device of claim 5, wherein
the first limiter, when the pilot signal extracted from the first demodulated signal has a power which is less than a predetermined value, outputs to the first loop filter a result of multiplying the first phase error by a predetermined coefficient which is less than one, and otherwise outputs the first phase error to the first loop filter, and
the second limiter, when the pilot signal extracted from the second demodulated signal has a power which is less than the predetermined value, outputs to the second loop filter a result of multiplying the second phase error by a predetermined coefficient which is less than one, and otherwise outputs the second phase error to the second loop filter.

9. The carrier recovery device of claim 2, wherein
the selector includes
an averager configured to, when the first demodulated signal has been selected, obtain an average value of an amplitude of the pilot signal extracted from the second demodulated signal, and when the second demodulated signal has been selected, obtain an average value of an amplitude of the pilot signal extracted from the first demodulated signal, and
a parameter setter configured to, when the first demodulated signal has been selected, set a parameter for generating the first carrier into the first carrier recovery unit based on the average value obtained by the averager, and when the second demodulated signal has been selected, set a parameter for generating the second carrier into the second carrier recovery unit based on the average value obtained by the averager.

10. The carrier recovery device of claim 2, wherein
the first carrier recovery unit further includes
a first quadrature amplitude modulation (QAM) error detector configured to detect an error as a QAM signal from the first demodulated signal, and
a first selector configured to select the error detected by the first QAM error detector or the first phase error based on a switch signal, and output the selected error to the first loop filter, and
the second carrier recovery unit further includes
a second QAM error detector configured to detect an error as a QAM signal from the second demodulated signal, and
a second selector configured to select the error detected by the second QAM error detector or the second phase error based on the switch signal, and output the selected error to the second loop filter.

11. A carrier recovery device comprising:
a multiplier configured to multiply a baseband signal by a carrier, and output the result as a demodulated signal;
a pilot signal extractor configured to extract a pilot signal from the demodulated signal;
an error detector configured to detect a phase error in the pilot signal extracted from the demodulated signal;
a limiter configured to cause the phase error to decrease or remain the same based on the pilot signal extracted from the demodulated signal, and output the resultant phase error;
a loop filter configured to smooth the output of the limiter, and output the smoothed output; and
a variable frequency oscillator configured to generate a signal corresponding to the output of the loop filter, and output the signal as the carrier.

12. The carrier recovery device of claim 11, further comprising:
a phase noise detector configured to obtain a phase noise amount of the demodulated signal; and
a parameter setter configured to set a parameter for generating the carrier into at least one of the pilot signal extractor or the loop filter based on the phase noise amount obtained by the phase noise detector.

13. The carrier recovery device of claim 11, further comprising:
an averager configured to obtain an average value of an amplitude of the pilot signal extracted from the demodulated signal; and
a parameter setter configured to set a parameter for generating the carrier into at least one of the pilot signal extractor or the loop filter based on the average value obtained by the averager.

14. The carrier recovery device of claim 11, wherein
the limiter, when the pilot signal extracted from the demodulated signal has an amplitude less than a first predetermined value, outputs a result of multiplying the phase error by a predetermined coefficient which is less than one, and otherwise outputs the phase error.

15. The carrier recovery device of claim 14, wherein
the limiter, when the amplitude of the pilot signal extracted from the demodulated signal is less than a second predetermined value which is less than the first predetermined value, outputs a result of multiplying the phase error by a second predetermined coefficient which is less than the first predetermined coefficient.

16. The carrier recovery device of claim 11, wherein
the limiter, when the pilot signal extracted from the demodulated signal has a power less than a first predetermined value, outputs a result of multiplying the phase error by a predetermined coefficient which is less than one, and otherwise outputs the phase error directly.

17. A demodulator comprising:
a first carrier recovery unit configured to
multiply a baseband signal by a first carrier to obtain a first demodulated signal,
extract a pilot signal from the first demodulated signal, and
generate the first carrier based on a first phase error in the pilot signal extracted from the first demodulated signal;
a second carrier recovery unit configured to
multiply the baseband signal by a second carrier to obtain a second demodulated signal,
extract a pilot signal from the second demodulated signal, and
generate the second carrier based on a second phase error in the pilot signal extracted from the second demodulated signal;
a selector configured to select one of the first and second demodulated signals which has been obtained by one of the first and second carrier recovery units whose carrier recovery operation has reached a predetermined steady state earlier than that of the other, based on the first phase error and the second phase error, and output the selected demodulated signal; and
an equalizer configured to equalize the demodulated signal selected by the selector.

18. The demodulator of claim 17, wherein
the selector includes
a phase noise detector configured to obtain a phase noise amount of one of the first and second demodulated signals which has not been selected, and
a parameter setter configured to set a parameter for the equalizer based on the phase noise amount.

19. The demodulator of claim 17, wherein
the selector includes
an averager configured to obtain an average value of an amplitude of the pilot signal extracted from one of the first and second demodulated signals which has not been selected, and
a parameter setter configured to set a parameter for the equalizer based on the average value.

20. A demodulator comprising:
a multiplier configured to multiply a baseband signal by a carrier, and output the result as a demodulated signal;
a pilot signal extractor configured to extract a pilot signal from the demodulated signal;
an error detector configured to detect a phase error in the pilot signal extracted from the demodulated signal;
a limiter configured to cause the phase error to decrease or remain the same based on the pilot signal extracted from the demodulated signal, and output the resultant phase error;
a loop filter configured to smooth the output of the limiter, and output the smoothed output;
a variable frequency oscillator configured to generate a signal corresponding to the output of the loop filter, and output the signal as the carrier; and
an equalizer configured to equalize the demodulated signal.

21. The demodulator of claim 20, further comprising:
a phase noise detector configured to obtain a phase noise amount of the output of the loop filter; and
a parameter setter configured to set a parameter for the equalizer based on the phase noise amount.

22. The demodulator of claim 20, further comprising:
an averager configured to obtain an average value of an amplitude of the pilot signal extracted from the demodulated signal; and
a parameter setter configured to set a parameter for the equalizer based on the average value.

23. A carrier recovery method comprising:
a first carrier recovery step of
multiplying a baseband signal by a first carrier to obtain a first demodulated signal,
extracting a pilot signal from the first demodulated signal, and
generating the first carrier based on a first phase error in the pilot signal extracted from the first demodulated signal;
a second carrier recovery step of
multiplying the baseband signal by a second carrier to obtain a second demodulated signal,
extracting a pilot signal from the second demodulated signal, and
generating the second carrier based on a second phase error in the pilot signal extracted from the second demodulated signal; and
a selection step of selecting one of the first and second demodulated signals which has been obtained by one of the first and second carrier recovery steps whose carrier recovery operation has reached a predetermined steady state earlier than that of the other, based on the first phase error and the second phase error.

24. A carrier recovery method comprising:
a multiplication step of multiplying a baseband signal by a carrier, and outputting the result as a demodulated signal;
a pilot signal extraction step of extracting a pilot signal from the demodulated signal;
an error detection step of detecting a phase error in the pilot signal extracted from the demodulated signal;
a limitation step of causing the phase error to decrease or remain the same based on the pilot signal extracted from the demodulated signal, and outputting the resultant phase error;
a loop filter step of smoothing the phase error after processing by the limitation step; and
a variable frequency oscillation step of generating as the carrier a signal corresponding to the phase error smoothed by the loop filter step.
